(19) United States
(12) Patent Application Publication
(10) Pub. No.: US 2020/0255597 A1
(43) Pub. Date: Aug. 13, 2020

(54) POLY(IMIDE-AMIDE) COPOLYMER OR ITS PRECURSOR, COMPOSITION INCLUDING SAME, COMPOSITION FOR PREPARING SAME, ARTICLE, METHOD FOR PREPARING ARTICLE, AND DISPLAY DEVICE INCLUDING ARTICLE

(71) Applicant: SAMSUNG ELECTRONICS CO., LTD., Suwon-si (KR)

(72) Inventors: Ha Na KIM, Yongin-si (KR); Yoon Seok KO, Suwon-si (KR); Hyun Seok CHOI, Seoul (KR); Ju Hyun KIM, Anyang-si (KR); Byunghee SOHN, Yongin-si (KR); Sungwon CHOI, Hwaseong-si (KR)

(21) Appl. No.: 16/783,288

(22) Filed: Feb. 6, 2020

(30) Foreign Application Priority Data
Feb. 11, 2019 (KR) 10-2019-0015760

(51) Int. Cl. C08G 73/10; C08J 5/18

(52) U.S. Cl. CPC C08G 73/1078; C08G 73/1017; C08J 2379/08; C08G 73/1053; C08J 5/18; C08G 73/1039

(57) ABSTRACT

A poly(imide-amide) copolymer or its precursor includes two ends and a main chain located between the two ends, and includes a group represented by Chemical Formula 1 at one end, and a structural unit represented by Chemical Formula 7, and at least one of a structural unit represented by Chemical Formula 2 or a structural unit represented by Chemical Formula 3 in the main chain:

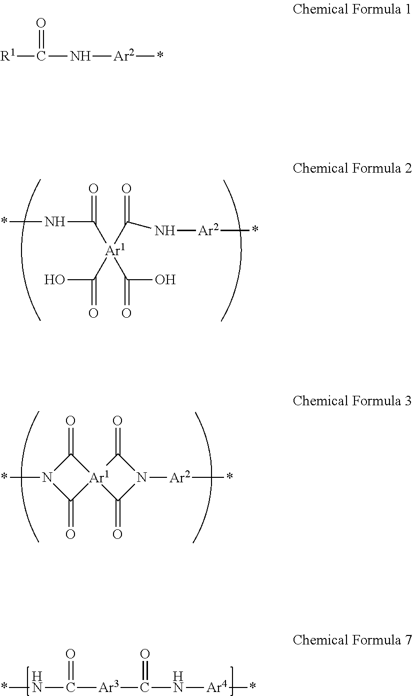

wherein, in Chemical Formulae 1, 2, 3, and 7, R¹ and Ar¹ to Ar⁴ are the same as defined in the detailed description.

### CROSS-REFERENCE TO RELATED APPLICATION

This application claims priority to Korean Patent Application No. 10-2019-0015760 filed in the Korean Intellectual Property Office on Feb. 11, 2019, and all the benefits accruing therefrom under 35 U.S.C. § 119, the content of which in its entirety is herein incorporated by reference.

### BACKGROUND

### 1. Field

A poly(imide-amide) copolymer or its precursor, a composition including the poly(imide-amide) copolymer or its precursor, a composition for preparing the poly(imide-amide) copolymer, an article prepared from the poly(imide-amide) copolymer, a method for preparing the article, a display device including the article are disclosed.

### 2. Description of the Related Art

Research efforts have been undertaken to produce a colorless transparent material that is suitable for diverse purposes, such as for an optical lens, a functional optical film, and a disk substrate. However, as information devices are being further miniaturized and display devices are providing higher resolution, more functions and greater optical or mechanical performance are required of the materials. Therefore, there is an unmet need to develop a colorless transparent material having improved transparency, heat resistance, mechanical strength, and flexibility.

### SUMMARY

An embodiment provides a novel poly(imide-amide) copolymer or its precursor having storage stability, improved solubility, and processability, and being capable of facile chain-extending.

Another embodiment provides a composition including the poly(imide-amide) copolymer or its precursor.

Another embodiment provides a composition for preparing the poly(imide-amide) copolymer or its precursor.

Another embodiment provides an article including the poly(imide-amide) copolymer.

Another embodiment provides a method of preparing the article from the composition.

Another embodiment provides a display device including the article.

An embodiment provides a poly(imide-amide) copolymer or its precursor including

two ends and a main chain located between the two ends,

a group represented by Chemical Formula 1 at one end, and a structural unit represented by Chemical Formula 7, and at least one of a structural unit represented by Chemical Formula 2 or a structural unit represented by Chemical Formula 3 in the main chain:

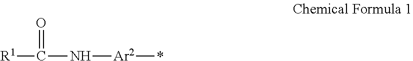

wherein, in Chemical Formula 1,

R¹ is a C4 to C10 tertiary alkoxy group, a C3 to C10 cycloalkoxy group, a R^{a}—CH═CH—O— group wherein R^{a} is hydrogen or substituted or unsubstituted C1 to C8 alkyl group, a R^{b}—CH═CH—CH₂—O— group wherein R^{b} is hydrogen or substituted or unsubstituted C1 to C7 alkyl group, a substituted phenyloxy group, a substituted or unsubstituted benzyloxy group, or a 9-fluorenylmethyloxy group, and

A² includes a substituted or unsubstituted C6 to C30 aromatic organic group, wherein the substituted or unsubstituted C6 to C30 aromatic organic group is present as a substituted or unsubstituted single aromatic ring; a fused ring including two or more substituted or unsubstituted aromatic rings; or a ring system comprising two or more of the substituted or unsubstituted single aromatic ring and/or the fused ring that are linked by a single bond, a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— wherein 1≤p≤10, —(CF₂)_{q}— wherein 1≤q≤10, —C(CH₃)₂—, —C(CF₃)₂—, —C(═O)NH—, or a combination thereof;

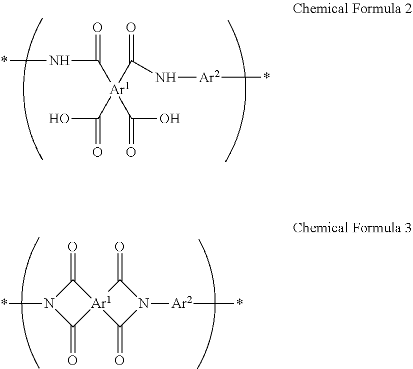

wherein, in Chemical Formula 2 or Chemical Formula 3,

Ar² is the same as defined in Chemical Formula 1, and

Ar¹ is a substituted or unsubstituted C6 to C30 aromatic organic group, wherein the substituted or unsubstituted C6 to C30 aromatic organic group is present as a substituted or unsubstituted single aromatic ring; a fused ring including two or more substituted or unsubstituted aromatic rings; a group represented by Chemical Formula 4, or a combination thereof:

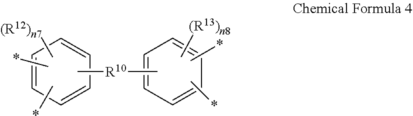

wherein, in Chemical Formula 4,

R¹⁰ is a single bond, —O—, —S—, —C(═O)—, —CH(OH)—, —C(═O)NH—, —S(═O)₂—, —Si(CH₃)₂—, —(CH₂)ₚ— wherein 1≤p≤10, —(CF₂)_{q}— wherein 1≤q≤10, —C(CₙH₂ₙ₊₁)₂— or —C(CₙF₂ₙ₊₁)₂— wherein 1≤n≤10, —(CH₂)ₚ—C(CₙH₂ₙ₊₁)₂—(CH₂)_{q}— or —(CH₂)ₚ—C(CₙF₂ₙ₊₁)₂—(CH₂)_{q}— wherein 1≤n≤10, 1≤p≤10, and 1≤q≤10, or a combination thereof,

R¹² and R¹³ are independently a halogen, a hydroxy group, a substituted or unsubstituted C1 to C10 aliphatic organic group, a substituted or unsubstituted C6 to C20 aromatic organic group, a —OR²⁰¹ group wherein R²⁰¹ is a C1 to C10 aliphatic organic group, or a —SiR²¹⁰R²¹¹R²¹² group wherein R²¹⁰, R²¹¹, and R²¹² are independently hydrogen or a C1 to C10 aliphatic organic group, and

n7 and n8 are independently one of integers of 0 to 3; and

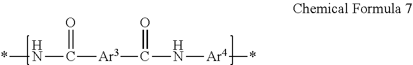

In Chemical Formula 7,

Ar³ is a substituted or unsubstituted phenylene group, or a substituted or unsubstituted biphenylene group, and

Ar⁴ is the same as Ar² defined in Chemical Formula 1.

R¹ of Chemical Formula 1 may be a t-butoxy group, 2-methyl-2-butoxy group, C10 cycloalkoxy group, vinyloxy group, allyloxy group, n-nitrophenyloxy group, nitrobenzyloxy group, or a benzyloxy group.

R¹ of Chemical Formula 1 may be a t-butoxy group or a benzyloxy group.

Ar² of Chemical Formula 1, Chemical Formula 2, and Chemical Formula 3 may independently be a group where substituted or unsubstituted two aromatic rings are linked by a single bond, a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— wherein —(CF₂)_{q}— wherein 1≤q≤10, —C(CH₃)₂—, —C(CF₃)₂—, —C(═O)NH—, or a combination thereof.

Ar² of Chemical Formula 1, Chemical Formula 2, and Chemical Formula 3 may independently be a group where two aromatic rings, each of which is substituted with an electron withdrawing group, are linked by a single bond.

Ar² of Chemical Formula 1, Chemical Formula 2, and Chemical Formula 3 may be represented by the following chemical formula:

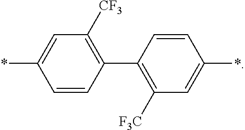

In Chemical Formula 4, R¹⁰ may be a single bond, —O—, —S—, —C(═O)—, —CH(OH)—, —C(═O)NH—, —S(═O)₂—, —Si(CH₃)₂—, —(CH₂)ₚ— wherein 1≤p≤3, —(CF₂)_{q}— wherein 1≤q≤3, —C(CₙH₂ₙ₊₁)₂— or —C(CₙF₂ₙ₊₁)₂— wherein 1≤n≤10, —(CH₂)ₚ—C(CₙH₂ₙ₊₁)₂—(CH₂)_{q}— or —(CH₂)ₚ—C(CₙF₂ₙ₊₁)₂—(CH₂)_{q}— wherein 1≤n≤10, 1≤p≤3, and 1≤q≤3, or a combination thereof.

Ar¹ of Chemical Formula 2 or Chemical Formula 3 may include the group represented by Chemical Formula 4.

R¹⁰ of Chemical Formula 4 may include a single bond, —C(CF₃)₂—, or a combination thereof.

Ar³ of Chemical Formula 7 may be a substituted or unsubstituted phenylene group, and Ar⁴ of Chemical Formula 7 may be a group where two of substituted or unsubstituted phenylene groups are linked by a single bond.

Ar³ of Chemical Formula 7 may be an unsubstituted phenylene group, and Ar⁴ of Chemical Formula 7 may be represented by the following chemical formula:

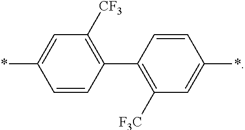

The poly(imide-amide) copolymer may include one of the group represented by Chemical Formula 8 or Chemical Formula 9 at the other end thereof:

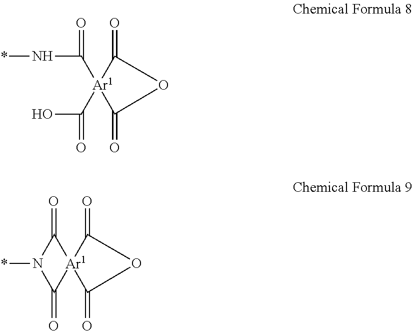

wherein, in Chemical Formula 8 or Chemical Formula 9,

Ar¹ is the same as defined in Chemical Formula 2 or Chemical Formula 3.

Another embodiment provides a composition for preparing a poly(imide-amide) copolymer or its precursor including a compound represented by Chemical Formula 11, and a compound represented by Chemical Formula 12:

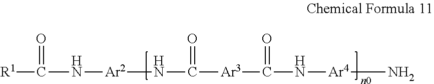

wherein, in Chemical Formula 11,

R¹ and Ar² are independently the same as defined in Chemical Formula 1,

Ar¹ is the same as defined in Chemical Formula 2 or Chemical Formula 3,

Ar⁴ is the same as defined in Chemical Formula 7, and

n0 is an integer greater than or equal to 1;

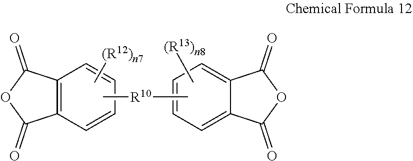

In Chemical Formula 12,

R¹⁰, R¹², R¹³, n7, and n8 are each independently the same as defined in Chemical Formula 4.

Both Ar² and Ar⁴ of Chemical Formula 11 may be represented by the following chemical formula:

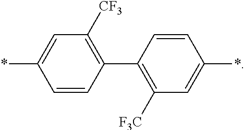

The compound represented by Chemical Formula 12 may include a compound represented by Chemical Formula 12-1 and a compound represented by Chemical Formula 12-2:

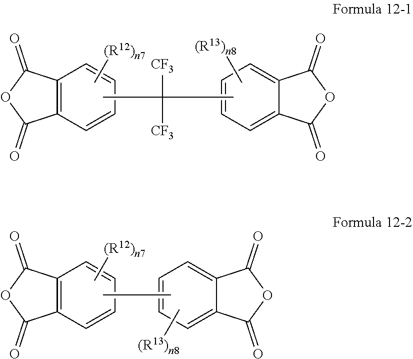

wherein in Chemical Formula 12-1 and Chemical Formula 12-2, and

R¹², R¹³, n7, and n8 are each independently the same as defined in Chemical Formula 4.

The composition for preparing the poly(imide-amide) copolymer or its precursor may further include a compound represented by Chemical Formula 14:

NH₂—Ar²—NH₂ Chemical Formula 14

wherein in Chemical Formula 14,

Ar² is the same as defined in Chemical Formula 11.

Another embodiment provides an article including the poly(imide-amide) copolymer according to the embodiment.

Another embodiment provides a method for preparing the article including coating the composition including the poly(imide-amide) copolymer or its precursor according to the embodiment and a solvent on a substrate to form a film, and heating the same to remove the solvent at a temperature greater than or equal to which the end group represented by Chemical Formula 1 of the poly(imide-amide) copolymer or its precursor in the composition is converted to a group represented by Chemical Formula 15, and the poly(imide-amide) copolymer or its precursor may polymerize to form a chain-extended poly(imide-amide) copolymer. The step of heating can be conducted in a single step or multiple steps as long as sufficient heating is used in terms of time and temperature to remove the solvent at a temperature greater than or equal to which the end group represented by Chemical Formula 1 of the poly(imide-amide) copolymer or its precursor in the composition is converted to a group represented by Chemical Formula 15, and the poly(imide-amide) copolymer or its precursor may polymerize to form a chain-extended poly(imide-amide) copolymer.

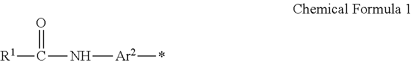

wherein, in Chemical Formula 1,

R¹ is a C4 to C10 tertiary alkoxy group, a C3 to C10 cycloalkoxy group, a R^{a}—CH═CH—O— group wherein Rₐ is hydrogen or substituted or unsubstituted C1 to C8 alkyl group, a R^{b}—CH═CH—CH₂—O— group wherein R_{b} is hydrogen or substituted or unsubstituted C1 to C7 alkyl group, a substituted or unsubstituted phenyloxy group, a substituted or unsubstituted benzyloxy group, or a 9-fluorenylmethyloxy group, and

Ar² includes a substituted or unsubstituted C6 to C30 aromatic organic group, wherein the substituted or unsubstituted C6 to C30 aromatic organic group is present as a substituted or unsubstituted single aromatic ring; a fused ring including two or more substituted or unsubstituted aromatic rings; or a ring system comprising two or more of the substituted or unsubstituted single aromatic ring and/or the fused ring that are linked by a single bond, a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— wherein 1≤p≤10, —(CF₂)_{q}— wherein 1≤q≤10, —C(CH₃)₂—, —C(CF₃)₂—, —C(═O)NH—, or a combination thereof;

NH₂—Ar²—* Chemical Formula 15

wherein in Chemical Formula 15, Ar² is the same as defined in claim 1.

Another embodiment provides a display device including an article according to the embodiment or an article prepared by the method according to the embodiment.

Hereinafter, the embodiments are described in detail.

The poly(imide-amide) copolymer or a precursor thereof according to an embodiment has an amino group at least one end, which is capped with a protecting group to prevent or minimize additional polymerization of the copolymer or precursor thereof, and thus, it may have storage stability and may maintain a predetermined molecular weight. Accordingly, the poly(imide-amide) copolymer or the precursor shows a relatively high solubility in a solvent and a low viscosity, and thus, excellent processability. Therefore, a composition including the poly(imide-amide) copolymer or the precursor has excellent coating properties, and thus, may be formed into a thin film. In addition, the composition may be heated to deblock the protecting group at one end of the oligomer to expose an amino group, and thus, a polymer may be obtained through additional polymerization reaction at the amino group. Accordingly, an article prepared by curing the composition includes a polymer having a relatively greater molecular weight than the previously stored poly(imide-amide) copolymer or the precursor, and thus, may exhibit excellent mechanical and optical properties.

### DETAILED DESCRIPTION

Hereinafter, embodiments will hereinafter be described in detail so that a person skilled in the art would understand. However, embodiments may be embodied in many different forms and is not construed as limited to the embodiments set forth herein. The terminology used herein is for the purpose of describing particular embodiments only and is not intended to be limiting.

The term “or” means “and/or”. As used herein, the term “and/or” includes any and all combinations of one or more of the associated listed items. Expressions such as “at least one of,” when preceding a list of elements, modify the entire list of elements and do not modify the individual elements of the list. As used herein, the singular forms “a”, “an”, and “the” are intended to include the plural forms as well, unless the context clearly indicates otherwise.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

As used herein, when a definition is not otherwise provided, the term ‘substituted’ may refer to replacement of a hydrogen atom of a compound or a functional group by a substituent selected from a halogen atom, a hydroxy group, an alkoxy group, a nitro group, a cyano group, an amino group, an azido group, an amidino group, a hydrazino group, a hydrazono group, a carbonyl group, a carbamoyl group, a thiol group, an ester group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C7 to C30 arylalkyl group, a C1 to C30 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C3 to C30 heterocycloalkyl group, or a combination thereof.

As used herein, when a definition is not otherwise provided, the term ‘hetero’ may refer to inclusion of 1 to 3 hetero atoms selected from N, O, S, Se, and P.

As used herein, the term “alkyl group” refers to a straight or branched chain saturated aliphatic hydrocarbon group having the specified number of carbon atoms and having a valence of at least one. Non-limiting examples of the alkyl group are methyl, ethyl, and propyl.

As used herein, the term “cycloalkyl group” may refer to a monovalent group having one or more saturated rings in which all ring members are carbon.

As used herein, the term “alkoxy group” refers to “alkyl-O—”, wherein the term “alkyl” has the same meaning as described above. Non-limiting examples of the alkoxy group are methoxy, ethoxy, and propoxy.

As used herein, the term “cycloalkyl group” may refer to a monovalent group having one or more saturated rings in which all ring members are carbon. Non-limiting examples of the alkyl group are cyclopentyl and cyclohexyl.

As used herein, the term “cycloalkyloxy group” refers to “cycloalkyl-O—”, wherein the term “cycloalkyl” has the same meaning as described above. Non-limiting examples of the cycloalkoxy group are cyclopentyloxy and cyclohexyloxy.

As used herein, the term “tertiary alkoxy group” refers to “tert-alkyl-O—”, wherein the term “tert-alkyl” is a tertiary alkyl group. Non-limiting examples of the alkoxy group are t-butoxy and 2-methyl-2-butoxy.

As used herein, the term “vinyloxy group” refers to “R—CH═CH—O—”, wherein R is hydrogen or an alkyl group.

As used herein, the term “allyloxy group” refers to “R—CH═CH—CH₂—O—”, wherein R is hydrogen or an alkyl group.

As used herein, the term “phenyloxy group” refers to “C₆H₅—O—”.

As used herein, the term “benzyloxy group” refers to “C6H5—CH₂—O—”.

An optically transparent heat resistant polymer is usefully applied to various optoelectronic devices, for example, an image device, a liquid crystal alignment layer, a color filter, an optical compensation film, an optic fiber, a light guide panels, optical lens, and the like. In this regard, recent research on realizing a remarkably light and flexible display panel by replacing a fragile inorganic glass substrate (e.g., about 300 nanometer (nm) to about 700 millimeter (mm) thick) in an image device with a plastic substrate (less than about 50 mm thick) has drawn attention. However, the plastic substrate has not yet been found reliable, because it is difficult to simultaneously accomplish optical transmittance, heat resistance, dimensional stability (thermal dimensional stability) at a thermal cycle during the assembly process of a device, film flexibility, and film-forming process compatibility (a solution process) in a high level. The plastic substrate has excellent flexibility and thin film formality, but is inferior in terms of heat resistance and thermal dimensional stability, compared with the inorganic glass substrate.

Aromatic polyimides (PI) or poly(imide-amide) (PIA) copolymers are well-known as high performance materials for their excellent thermal stabilities and balanced mechanical and electrical properties, and may be considered as the prospective candidates for materials in optoelectronic devices. Highly concentrated polymer resin with a low viscosity is greatly desired in order to prepare a PI or a PIA film having good mechanical, thermal, and optical properties by using a solution casting method. This may be achieved by decreasing molecular weight of the precursor of a polyimide or poly(imide-amide) copolymer without impairing the thermal and mechanical properties of the final material. A solution consisting of oligomers may have a much lower solution viscosity. A solid content of such a solution may be increased. Oligomers, however, exhibit poor mechanical properties compared with higher molecular weight polymers. In this regard, many significant research efforts has been undertaken to develop a polyamic acid having a reduced viscosity through process improvements such as, a thermal treatment at about 50° C. to about 70° C., addition of water as a co-solvent (Ebisawa S. et al. Eur. Polym. J. 46, 283-297 2010), and the like. Nevertheless, there are some disadvantages from the perspective of practical application that this reduction in polyamic acid viscosity is caused by a decrease in molecular weight of polyamic acid leading to the degradation of polymer and deteriorating mechanical properties of polyimide.

One of possible ways to reduce solution viscosity consists of introducing small amounts of tetracarboxylic acid as a potential reactant in place of the corresponding dianhydride. These monomers may not react at room temperature, but upon heating, they are converted back to dianhydrides which participate in chain extension during a curing process (Rabilloud G. High-performance Polymers: Chemistry and Applications, V2, 1999).

Thermoset polyimide derived from reactive end-capped imide monomers or oligomers has been achieved to balance the trade-off between high temperature capability and excellent processing characteristics. Other oligomers that are end-capped with different end-cappers, such as a silane or ethynyl end-capper, provide highly concentrated resin of moderate viscosity.

In addition, “an ester technique” has been developed to produce a short chain oligomer as a polyimide precursor. First, dianhydrides are partially esterified, and then reacted with diamine to produce “salt-like” oligomers solution (Cano R. J. et.al. High Performance Polym., 13, 235-250, 2001). After heating them, high molecular weight polyimide is produced. Another approach is to use acetylated diamines to synthesize polyamic acid with an acetyl end-group, and to produce a solution having a low viscosity and high solid content (Kreuz J. A. Polymer, 36, 2089-2094, 1995).

A solid chain extension polymerization reaction between Lewis acid oligomers and deblocked Lewis bases is performed, and a high molecular weight polymer is obtained (U.S. Pat. Nos. 5,382,637; 6,017,682). Negative resist has been prepared by selectively exposing a region of the solid state film. The Lewis base is deblocked at the exposed region. The Lewis acid oligomer and the deblocked Lewis base extend a chain at an exposed area. As an example of Lewis acid oligomer an anhydride-terminated oligoimide is used, and as an example of blocked Lewis base a tert-butoxy carbonyl (t-BOC)protected diamine is used.

The present inventors discovered a new poly(imide-amide) copolymer having an excellent solubility in solvent and a low viscosity, without being substantially decreased in molecular weight, and thus, the poly(imide-amide) copolymer exhibits excellent processability such as coating and the like, and may be polymerizable into a polymer having a high molecular weight through curing after coating in the absence of an additional chain extender and the like. The new poly(imide-amide) copolymer has a protected amino group at one end, a polyamic acid or a polyimide structural unit, and a polyamide structural unit in the main chain. The poly(imide-amide) copolymer has an end-capped amino group, and accordingly, may minimize additional reaction of the copolymer end group during storage. As a result, the copolymer maintains a predetermined molecular weight range, and exhibits excellent solubility in a solvent with a relatively low increase, if any, in viscosity. Accordingly, a composition including the poly(imide-amide) copolymer and a solvent may be easily coated on a substrate and the like and formed into a thin film. When the composition is heat-treated after the coating the protecting group at one end of the poly(imide-amide) copolymer is cleaved, and the deblocked amino group at one end of the poly(imide-amide) copolymer additionally reacts with an anhydride terminal end in the composition, and thus, the poly(imide-amide) copolymer may be converted into a polymer having a larger molecular weight. Accordingly, an article prepared by coating and curing the composition includes a polymer having a relatively greater molecular weight than the stored copolymer, and thus, may exhibit excellent mechanical, thermal, and optical properties.

Specifically, an embodiment provides a poly(imide-amide) copolymer including two ends and a main chain located between the two ends, a group represented by Chemical Formula 1 at one end, and a structural unit represented by Chemical Formula 7, and at least one of a structural unit represented by Chemical Formula 2 or a structural unit represented by Chemical Formula 3 in the main chain:

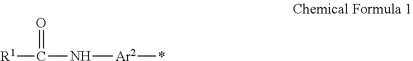

In Chemical Formula 1,

R¹ is a C4 to C10 tertiary alkoxy group (for example, a t-butoxy group, or a 2-methyl-2-butoxy group), a C3 to C10 cycloalkoxy group, a R^{a}—CH═CH—O— group wherein Rₐ is hydrogen or substituted or unsubstituted C1 to C8 alkyl group (for example, vinyloxy group), a R^{b}—CH═CH—CH₂—O— group wherein R_{b} is hydrogen or substituted or unsubstituted C1 to C7 alkyl group (for example, allyloxy group), a substituted or unsubstituted phenyloxy group (for example, a nitrophenyloxy group), a substituted or unsubstituted benzyloxy group (for example, a nitrobenzyloxy group, or a benzyloxy group), or a 9-fluorenylmethyloxy group, and

Ar² includes a substituted or unsubstituted C6 to C30 aromatic organic group, wherein the substituted or unsubstituted C6 to C30 aromatic organic group is present as a substituted or unsubstituted single aromatic ring; a fused ring including two or more substituted or unsubstituted aromatic rings; or a ring system comprising two or more of the substituted or unsubstituted single aromatic ring and/or the fused ring that are linked by a single bond, a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CH₃)₂—, —C(CF₃)₂—, —C(═O)NH—, or a combination thereof;

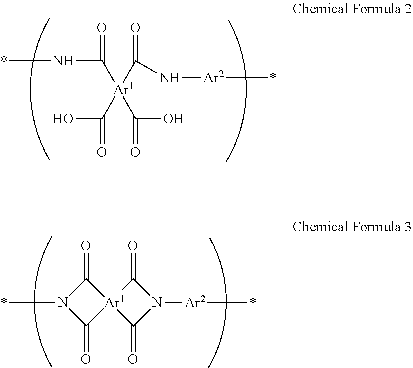

In Chemical Formula 2 or Chemical Formula 3,

Ar² is the same as defined in Chemical Formula 1,

Ar¹ is a substituted or unsubstituted C6 to C30 aromatic organic group, wherein the substituted or unsubstituted C6 to C30 aromatic organic group is present as a substituted or unsubstituted single aromatic ring; a fused ring including two or more substituted or unsubstituted aromatic rings; a group represented by Chemical Formula 4, or a combination thereof:

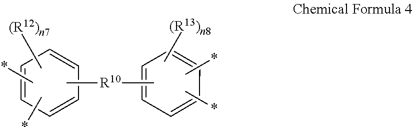

In Chemical Formula 4,

R¹⁰ is a single bond, —O—, —S—, —C(═O)—, —CH(OH)—, —C(═O)NH—, —S(═O)₂—, —Si(CH₃)₂—, —(CH₂)ₚ— (wherein, 1≤p≤10), —(CF₂)_{q}— (wherein, 1≤q≤10), —C(CₙH₂ₙ₊₁)₂—, —C(CₙF₂ₙ₊₁)₂—, —(CH₂)p—C(CₙH₂ₙ₊₁)₂—(CH₂)_{q}—, —(CH₂)ₚ—C(CₙF₂ₙ₊₁)₂—(CH₂)_{q}— (wherein 1≤n≤10, 1≤p≤10, and 1≤q≤10), or a combination thereof,

R¹² and R¹³ are independently a halogen, a hydroxy group, a substituted or unsubstituted C1 to C10 aliphatic organic group, a substituted or unsubstituted C6 to C20 aromatic organic group, a —OR²⁰¹ group (wherein, R²⁰¹ is a C1 to C10 aliphatic organic group), or a —SiR²¹⁰R²¹¹R²¹² group (wherein R²¹⁰, R²¹¹, and R²¹² are independently hydrogen or a C1 to C10 aliphatic organic group), and

n7 and n8 are independently one of integers of 0 to 3; and

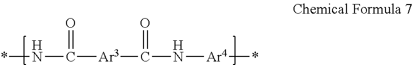

In Chemical Formula 7,

Ar³ is a substituted or unsubstituted phenylene group, of a substituted or unsubstituted biphenylene group, and

Ar⁴ is the same as Ar² of Chemical Formula 1.

The structural unit represented by Chemical Formula 2 is a structural unit forming a polyamic acid, the structural unit represented by Chemical Formula 3 is a structural unit forming polyimide. When the polymer according to an embodiment includes a structural unit represented by Chemical Formula 2 and a structural unit represented by Chemical Formula 7, the polymer may be referred to as a poly(amic acid-amide) copolymer. When the polymer according to an embodiment includes a structural unit represented by Chemical Formula 3 and a structural unit represented by Chemical Formula 7, the polymer may be referred to as a poly(imide-amide) copolymer. The poly(amic acid-amide) copolymer including the structural unit represented by Chemical Formula 2 and the structural unit represented by Chemical Formula 7 may be a precursor of the poly(imide-amide) copolymer including a structural unit represented by Chemical Formula 3 and a structural unit represented by Chemical Formula 7. That is, the poly(amic acid-amide) copolymer may be imidized to prepare a poly(imide-amide) copolymer by using a thermal imidization or a chemical imidization using an imidizing agent.

In an exemplary embodiment, if the copolymer includes the structural unit represented by Chemical Formula 2 and the structural unit represented by Chemical Formula 7 in the main chain, this may be a poly(amic acid-amide) copolymer, and if the copolymer includes the structural unit represented by Chemical Formula 3 and the structural unit represented by Chemical Formula 7 in the main chain, this may be a poly(imide-amide) copolymer. In addition, if the copolymer includes the structural unit represented by Chemical Formula 7, and both of the structural units represented by Chemical Formula 2 and Chemical Formula 3, this may be a partially imidized poly(amic acid/imide-amide) copolymer. Accordingly, in an exemplary embodiment, the copolymer may be a poly(amic acid-amide) copolymer, a poly(imide-amide) copolymer, a poly(amic acid/imide-amide) copolymer, or a combination thereof.

In an exemplary embodiment, R¹ of Chemical Formula 1 may be a t-butoxy group, a C10 cycloalkoxy group, an n-nitrophenyloxy group, a nitrobenzyloxy group, or a benzyloxy group, for example, R¹ of Chemical Formula 1 may be a t-butoxy group or a benzyloxy group, for example, R¹ of Chemical Formula 1 may be a t-butoxy group. If R¹ of Chemical Formula 1 is a t-butoxy group and the composition including the poly(imide-amide) copolymer or a precursor thereof is heat-treated, a t-butoxy carbonyl group linked with an amino group at one end of the poly(imide-amide) copolymer or a precursor thereof may easily be removed. Accordingly, a poly(imide-amide) copolymer or a precursor thereof including an exposed amino group at an end may be additionally polymerized with an anhydride at one end of another poly(imide-amide) copolymer or a precursor thereof to form a poly(imide-amide) copolymer or a precursor thereof having an extended chain length.

As shown in the structure of Chemical Formula 2 or Chemical Formula 3, Ar² may be derived from a diamine selected for preparing a polyamic acid or a polyimide, and therefore, Ar² of Chemical Formula 1, Chemical Formula 2, or Chemical Formula 3 may independently be a group where substituted or unsubstituted two aromatic rings may be linked by a single bond, or a functional group of a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— (wherein, 1≤p≤10), —(CF₂)_{q}— (wherein, 1≤q≤10), —C(CH₃)₂—, —C(CF₃)₂—, —C(═O)NH—, or a combination thereof.

In an exemplary embodiment, Ar² may be a group where substituted two aromatic rings are linked by a single bond, for example, a group where two aromatic rings which are respectively substituted with an electron withdrawing group and are linked by a single bond. In an exemplary embodiment, the aromatic ring may independently be a phenylene group, the electron withdrawing group may be selected from —CF₃, —Cl₃, —CBr₃, —Cl₃, —NO₂, —CN, —COCH₃, or —CO₂C₂H₅, and in an exemplary embodiment, the electron withdrawing group may be —CF₃. In an exemplary embodiment, the Ar² may be represented by chemical formula:

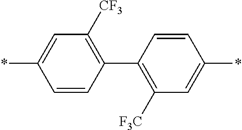 [SMILES: *c1ccc(-c2ccc(*)cc2C(F)(F)F)c(C(F)(F)F)c1]

In an exemplary embodiment, Ar¹ of Chemical Formula 2 or Chemical Formula 3 may independently be a substituted or unsubstituted C6 to C30 arbitrary aromatic organic group, a group where two substituted or unsubstituted benzene rings are linked by a single bond or a predetermined linking group as shown in Chemical Formula 4. In a plurality of structural units of the poly(imide-amide) copolymer or a precursor thereof, Ar¹ may be the same or different in each structural unit, or Ar¹ may be a combination of different groups. If Ar¹ includes a substituted or unsubstituted C6 to C30 aromatic organic group, and/or the group represented by Chemical Formula 4 alone, the poly(imide-amide) copolymer or a precursor thereof consisting of such structural units alone may be a general poly(imide-amide) copolymer or a precursor thereof.

As shown in the structure of Chemical Formula 2 or Chemical Formula 3, Ar¹ may be derived from a tetracarboxylic acid dianhydride selected for preparing a polyamic acid or polyimide.

In Chemical Formula 2 or Chemical Formula 3, if Ar¹ is a substituted or unsubstituted C6 to C30 aromatic organic group, it may be a C6 to C30 substituted or unsubstituted aromatic single ring or a substituted or unsubstituted C6 to C30 aromatic fused ring. In an exemplary embodiment, Ar¹ may be an unsubstituted C6 aromatic organic group, i.e., a benzene ring.

In Chemical Formula 2 or Chemical Formula 3, if Ar¹ is the group represented by Chemical Formula 4, R¹⁰ may be a single bond, —O—, —S—, —C(═O)—, —CH(OH)—, —C(═O)NH—, —S(═O)₂—, —Si(CH₃)₂—, —(CH₂)ₚ— (wherein, 1≤p≤3), —(CF₂)_{q}— (wherein, 1≤p≤3), —(CF₂)_{q}— (wherein, 1≤q≤3), —C(CₙH₂ₙ₊₁)₂—, —C(CₙF₂ₙ₊₁)₂—, —(CH₂)ₚ—C(CₙH₂ₙ₊₁)₂—(CH₂)_{q}—, —(CH₂)ₚ—C(CₙF₂ₙ₊₁)₂—(CH₂)_{q}— (wherein 1≤n≤10, 1≤p≤3, and 1≤q≤3), or a combination thereof, for example, R¹⁰ may be a single bond, —O—, —S—, —C(═O)—, —S(═O)₂—, —C(CF₃)₂—, or a combination thereof, or for example, R¹⁰ may be a single bond, —(CF₃)₂—, or a combination thereof.

In an exemplary embodiment, Ar¹ of the structural unit represented by Chemical Formula 2 or the structural unit represented by Chemical Formula 3 may be the group represented by Chemical Formula 4. As described above, Chemical Formula 4 may be derived from a tetracarboxylic acid dianhydride where two aromatic rings are linked by a single bond or a predetermined linking group, and thus, may be derived from a tetracarboxylic acid dianhydride that are used during preparation of a polyimide.

If Ar¹ of the structural unit represented by Chemical Formula 2 or Chemical Formula 3 includes the group represented by Chemical Formula 4, R¹⁰ of Chemical Formula 4 may include a single bond or —C(CF₃)₂—, but is not limited thereto.

The structural unit represented by Chemical Formula 7 is an amide structural unit, which may be prepared by reacting a dicarboxylic derivative, for example, a halogenated aromatic dicarboxylic acid, for example, an aromatic dicarboxylic acid dichloride, with a diamine. If an amide structural unit is further included in a polyimide or a polyamic acid, the prepared polymer may have further improved mechanical and thermal properties compared with the polyimide or polyamic acid that does not include the amide structural unit.

The structural unit represented by Chemical Formula 7 may be prepared by reacting a halogenated aromatic dicarboxylic acid, for example, an aromatic dicarboxylic acid dichloride, with a diamine, for example, a diamine which is the same as or different from the diamine used for preparing an amic acid structural unit represented by Chemical Formula 2 or an imide structural unit represented by Chemical Formula 3. In an exemplary embodiment, a diamine for preparing the structural unit represented by Chemical Formula 7 may be the same as the diamine used for preparing the structural unit represented by Chemical Formula 2 or the diamine used for preparing the structural unit represented by Chemical Formula 3. Therefore, Ar¹ of the structural unit represented by Chemical Formula 7 may be the same as Ar² of Chemical Formula 2 or Chemical Formula 3.

In an exemplary embodiment, Ar³ in Chemical Formula 7 may be an unsubstituted phenylene group, an unsubstituted biphenylene group, or a combination thereof, and Ar⁴ in Chemical Formula 7 may be a group where two phenylene groups are linked by a single bond, each of the phenylene group is substituted by an electron withdrawing group. In an exemplary embodiment, Ar³ may be an unsubstituted phenylene group, and Ar⁴ may be represented by the following chemical formula:

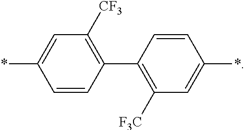

The poly(imide-amide) copolymer or a precursor thereof according to an embodiment may include the structural unit represented by Chemical Formula 7, and at least one of the structural unit represented by Chemical Formula 2 or the structural unit represented by Chemical Formula 3 in a mole ratio of from about 80:20 to about 20:80, for example, from about 75:25 to about 25:75, from about 70:30 to about 30:70, from about 65:35 to about 35:65, from about 60:40 to about 40:60, from about 55:45 to about 45:55, or about 50:50, but the ratio is not limited thereto. The mole ratio is not limited thereto and may be adjusted according desired characteristics such as for example, mechanical, optical, and/or thermal properties.

In an exemplary embodiment, the poly(imide-amide) copolymer or the poly(amic acid-amide) copolymer may further include one of groups represented by Chemical Formula 8 or Chemical Formula 9 at the other end:

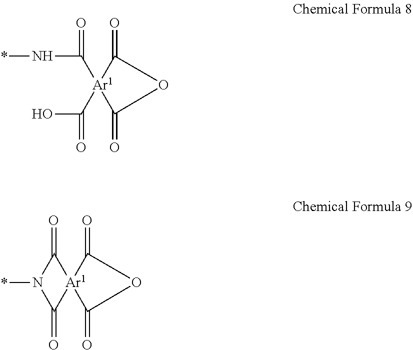

wherein, in Chemical Formula 8 or Chemical Formula 9,

Ar¹ is the same as defined in Chemical Formula 2 or Chemical Formula 3.

If the poly(imide-amide) copolymer or a poly(amic acid-amid) copolymer according to an embodiment has the group represented by Chemical Formula 1 at one end, and the group represented by Chemical Formula 8 or Chemical Formula 9 at the other end, and when the poly(imide-amide) copolymer or a poly(amic acid-amid) is heated, the group represented by Chemical Formula 1 is converted into an amino group, the amino group reacts with the group represented by Chemical Formula 8 or Chemical Formula 9 of another poly(imide-amide) copolymer or a poly(amic acid-amid) copolymer to form an additional imide bond, and the group represented by Chemical Formula 8 or Chemical Formula 9 at the other end of the poly(imide-amide) copolymer or the poly(amic acid-amid) copolymer reacts with an amino group of another poly(imide-amide) copolymer or a poly(amic acid-amid) copolymer to form an additional imide bond, and thus, the chain length of the poly(imide-amide) copolymer or a poly(amic acid-amid) copolymer is extended.

The poly(imide-amide) copolymer or a poly(amic acid-amid) copolymer according to an embodiment may be prepared by condensing/polymerizing diamine and dianhydride in a mole ratio of about 1:1 in a polar aprotic organic solvent, as well as adding a diamine substituted with the group represented by Chemical Formula 1, whereby the poly(imide-amide) copolymer or a poly(amic acid-amid) copolymer may have the group represented by Chemical Formula 1 at one end. In order to substitute one amino group of the diamine with the group represented by Chemical Formula 1, the diamine may be reacted with a compound represented by Chemical Formula 10.

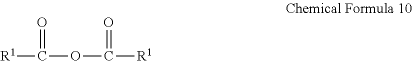

In Chemical Formula 10, R¹ is the same as defined in Chemical Formula 1, and in an exemplary embodiment, R¹ may be a t-butoxy group or a benzyloxy group.

The compound represented by Chemical Formula 10 and a diamine may be reacted in an organic solvent, as along with tetraethyl ammonium (TEA), to convert one amino group of the diamine into the group represented by Chemical Formula 1. The reaction may be represented by Reaction Scheme 1:

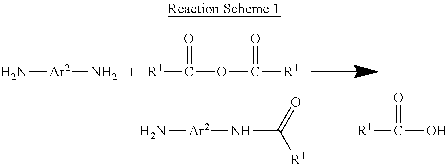

After dissolving the diamine having one end converted into Chemical Formula 1 along with a diamine having one end not converted into Chemical Formula 1 in a solvent, a tetracarboxylic acid dianhydride, and/or a dicarboxylic acid derivative is added to the solution and reacted therewith to prepare a poly(imide-amide) copolymer or a poly(amic acid-amide) copolymer having the group represented by Chemical Formula 1 at one end in the same manner as a method for preparing a polyamic acid. Herein, as one end of the diamine is converted into the group of Chemical Formula 1, a poly(imide-amide) copolymer or a poly(amic acid-amide) copolymer prepared therefrom has the group represented by Chemical Formula 1 at one end, and thus, does not react with an anhydride moiety of another polymer. Accordingly, the poly(imide-amide) copolymer or a poly(amic acid-amide) copolymer prepared through a reaction of a diamine and a dianhydride tends to have a lower molecular weight than a conventional polyamic acid prepared from a diamine and a dianhydride, and a molecular weight within a predetermined range can be achieved. Herein, a molecular weight of the poly(imide-amide) copolymer or a poly(amic acid-amide) copolymer may easily be adjusted by controlling an addition amount of the compound represented by Chemical Formula 10 to convert one end of a diamine into the group of Chemical Formula 1.

In an exemplary embodiment, the compound represented by Chemical Formula 10 may be included in a range of about 5 mole percent (mol %) to about 50 mol %, for example, about 5 mol % to about 45 mol %, about 5 mol % to about 40 mol %, about 5 mol % to about 35 mol %, about 5 mol % to about 30 mol %, about 10 mol % to about 50 mol %, about 10 mol % to about 45 mol %, about 10 mol % to about 40 mol %, about 10 mol % to about 35 mol %, about 10 mol % to about 30 mol %, about 20 mol % to about 50 mol %, about 20 mol % to about 45 mol %, about 20 mol % to about 40 mol %, about 20 mol % to about 35 mol %, or about 20 mol % to about 30 mol %, based on the total moles of the added diamine, and the amount is not limited thereto.

A poly(amic acid-amide) copolymer or a poly(imide-amide) copolymer prepared by including the compound represented by Chemical Formula 10 in an amount of the above range may have a molecular weight of about 50,000 grams per mole (g/mol) to 500,000 g/mol, for example, about 50,000 g/mol to 450,000 g/mol, about 50,000 g/mol to 400,000 g/mol, about 50,000 g/mol to 350,000 g/mol, about 50,000 g/mol to 3200,000 g/mol, about 50,000 g/mol to 250,000 g/mol, about 50,000 g/mol to 200,000 g/mol, about 80,000 g/mol to 300,000 g/mol, about 80,000 g/mol to 250,000 g/mol, about 80,000 g/mol to 200,000 g/mol, about 100,000 g/mol to 300,000 g/mol, about 100,000 g/mol to 250,000 g/mol, about 100,000 g/mol to 200,000 g/mol, about 120,000 g/mol to 300,000 g/mol, about 120,000 g/mol to 250,000 g/mol, about 120,000 g/mol to 200,000 g/mol, or about 120,000 g/mol to 180,000 g/mol, but the molecular weight is not limited thereto.

A person skilled in the art to which the invention pertain would be able to prepare a poly(imide-amide) copolymer or a poly(amic acid-imide) copolymer having a group derived from the compound represented by Chemical Formula 1 and a desired molecular weight by adjusting the amount of the compound represented by Chemical Formula 10 considering a desired use of the poly(imide-amide) copolymer or a poly(amic acid-imide) copolymer. The prepared poly(imide-amide) copolymer or a poly(amic acid-imide) copolymer may further be extended in length by being further heat-treated and cured to achieve a higher molecular weight. Accordingly, an article prepared from the chain-extended poly(imide-amide) copolymer or a poly(amic acid-imide) copolymer may exhibit further improved mechanical and/or thermal properties.

As described above, a poly(imide-amide) copolymer or a poly(amic acid-imide) copolymer according to an embodiment may be prepared by first reacting a diamine with a compound to convert an amino group to the group represented by Chemical Formula 1, i.e., the compound represented by Chemical Formula 10, to prepare an amine compound having a group represented by Chemical Formula 1 at one end, and the prepared amine compound is added to the reaction mixture including a diamine, a dianhydride, and a dicarboxylic acid derivative for prepare a poly(imide-amide) copolymer or a poly(amic acid-imide) copolymer to be polymerized therewith to prepare a poly(imide-amide) copolymer or a poly(amic acid-imide) copolymer according to an embodiment.

Alternatively, an oligomer including an amide structural unit prepared from a reaction between a diamine and a dicarboxylic acid derivative is first prepared, an amino group at an end of the prepared oligomer is then converted to the group represented by Chemical Formula 1 by reacting the oligomer with the compound represented by Chemical Formula 10, and the oligomers including an oligomer having a group represented by Chemical Formula 1 at one end are reacted with a tetracarboxylic acid dianhydride to prepare a poly(imide-amide) copolymer or a poly(amic acid-imide) copolymer having a group represented by Chemical Formula 1 at one end. In this case, the poly(imide-amide) copolymer or a poly(amic acid-imide) copolymer according to an embodiment may be prepared from a composition for preparing a poly(imide-amide) copolymer or a precursor, which includes a compound represented by Chemical Formula 11, and a compound represented by Chemical Formula 12:

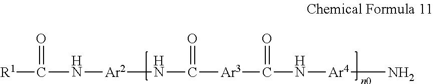

wherein in Chemical Formula 11,

R¹ and Ar² are the same as defined in Chemical Formula 1,

Ar³ and Ar⁴ are the same as defined in Chemical Formula 7, and

n0 is an integer of greater than or equal to 1;

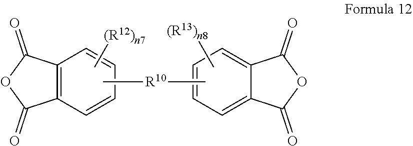

wherein in Chemical Formula 12,

R¹⁰, R¹², R¹³, n7 and n8 are each independently the same as defined in Chemical Formula 4.

In an exemplary embodiment, both of Ar² and Ar⁴ of Chemical Formula 11 may be represented by the following chemical formula:

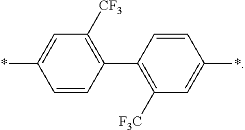

In an exemplary embodiment, the compound represented by Chemical Formula 12 may include at least one of the compounds represented by Chemical Formula 12-1 and Chemical Formula 12-2:

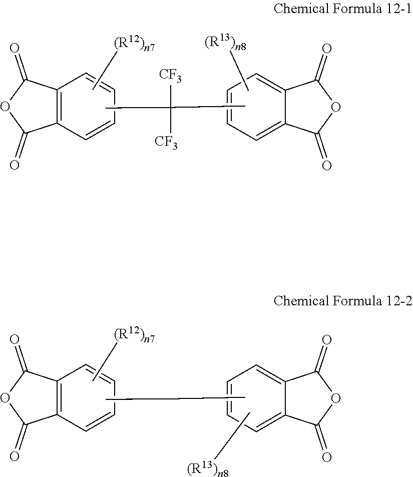

In Chemical Formula 12-1 and Chemical Formula 12-2,

R¹², R¹³, n7, and n8 are the same as defined in Chemical Formula 4, respectively.

The composition for preparing a poly(imide-amide) copolymer or its precursor may further include a compound represented by Chemical Formula 14:

NH₂—Ar²—NH₂ Chemical Formula 14

wherein in Chemical Formula 14,

Ar² is the same as defined in Chemical Formula 1.

In an exemplary embodiment, the compound represented by Chemical Formula 14 may be represented by at least one of Chemical Formula 14-1 to Chemical Formula 14-3:

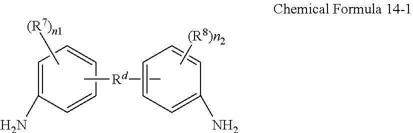

wherein, in Chemical Formula 14-1,

R^{d} is selected from the following chemical formulae:

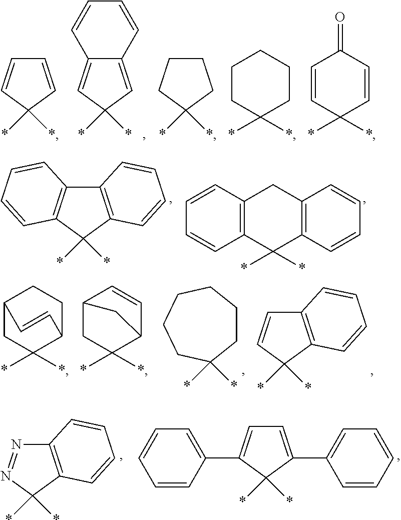

R⁷ and R⁸ are the same or different and are independently a halogen, a hydroxy group, an alkoxy group (—OR²⁰⁰, wherein R²⁰⁰ is a C1 to C10 aliphatic organic group), a silyl group (—SiR²⁰¹R²⁰²R²⁰³, wherein R²⁰¹, R²⁰², and R²⁰³ are the same or different and are independently hydrogen or a C1 to C10 aliphatic organic group), a substituted or unsubstituted C1 to C10 aliphatic organic group, or a C6 to C20 aromatic organic group, and

n1 and n2 are independently an integer ranging from 0 to 4;

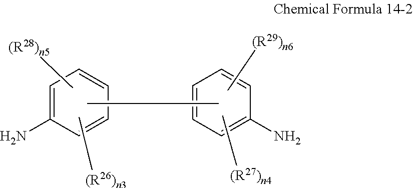

wherein, in Chemical Formula 14-2,

R²⁶ and R²⁷ are the same or different and are independently an electron withdrawing group selected from —CF₃, —CCl₃, —CBr₃, —Cl₃, —NO₂, —CN, —COCH₃, or —CO₂C₂H₅,

R²⁸ and R²⁹ are the same or different and are independently a halogen, a hydroxy group, an alkoxy group (—OR²⁰⁴, wherein R²⁰⁴ is a C1 to C10 aliphatic organic group), a silyl group (—SiR²⁰⁵R²⁰⁶R²⁰⁷, wherein R²⁰⁵, R²⁰⁶, and R²⁰⁷ are the same or different and are independently hydrogen, or a C1 to C10 aliphatic organic group), a substituted or unsubstituted C1 to C10 aliphatic organic group, or a C6 to C20 aromatic organic group,

n3 is an integer ranging from 1 to 4, n5 is an integer ranging from 0 to 3, and n3+n5 is an integer ranging from 1 to 4, and

n4 is an integer ranging from 1 to 4, n6 is an integer ranging from 0 to 3, and n4+n6 is an integer ranging from 1 to 4;

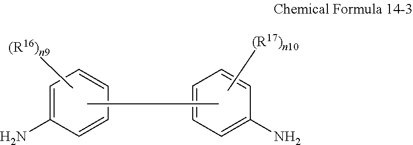

wherein, in Chemical Formula 14-3,

R¹⁴ includes O, S, C(═O), CH(OH), S(═O)₂, Si(CH₃)₂, (CH₂)ₚ (wherein, 1≤p≤10), (CF₂)_{q} (wherein, 1≤q≤10), C(CH₃)₂, C(CF₃)₂, C(═O)NH, or a substituted or unsubstituted C6 to C30 aromatic organic group, wherein the aromatic organic group is present as a single ring, a fused ring including two or more aromatic rings, or two or more rings of the single aromatic ring or the fused rings linked by a single bond, a fluorenylene group, O, S, C(═O), CH(OH), S(═O)₂, Si(CH₃)_{2,} (CH₂)ₚ (wherein, 1≤p≤10), (CF₂)_{q} (wherein, 1≤q≤10), C(CH₃)₂, C(CF₃)₂, or C(═O)NH,

R¹⁶ and R¹⁷ are the same or different and are independently a halogen, a hydroxy group, an alkoxy group (—OR²¹², wherein R²¹² is a C1 to C10 aliphatic organic group), a silyl group (—SiR²¹³R²¹⁴R²¹⁵, wherein R²¹³, R²¹⁴, and R²¹⁵ are the same or different and are independently hydrogen or a C1 to C10 aliphatic organic group), a substituted or unsubstituted C1 to C10 aliphatic organic group, or a C6 to C20 aromatic organic group, and

n9 and n10 are independently an integer ranging from 0 to 4.

In an exemplary embodiment, the diamine represented by Chemical Formula 14 may include the diamine represented by Chemical Formula Chemical Formula 14-2, and in Chemical Formula 14-2, R²⁶ and R²⁷ may be all —CF₃, n3 and n4 may be all 1, and n5 and n6 may be all 0. That is, in an exemplary embodiment, the diamine may be TFDB.

Another embodiment provides a composition including a poly(imide-amide) copolymer or a precursor thereof according to the embodiment and a solvent.

As described above, a poly(imide-amide) copolymer or a precursor thereof according to the embodiment has a lower molecular weight than the poly(imide-amide) copolymer or a precursor thereof having the same composition as the poly(imide-amide) copolymer or a precursor thereof according to the embodiment but not having the group represented by Chemical Formula 1 at one end. The viscosity of a solution containing the poly(imide-amide) copolymer or a precursor thereof according to the embodiment is nearly half that of a solution containing the same amount of a poly(imide-amide) copolymer or a precursor thereof that does not include the group represented by Chemical Formula 1 at one end even though the two solutions include the same amount of polymer. Accordingly, the solution containing the poly(imide-amide) copolymer or a precursor thereof according to the embodiment may be well coated on a substrate due to its relatively low viscosity such that a thin film may be prepared, and good processability may be obtained. Further, when preparing an article by curing the poly(imide-amide) copolymer or a precursor thereof according to the embodiment, the group represented by Chemical Formula 1 may convert to an amino group, whereby further polymerization reaction may proceed to extend the length of the chain of the polymers to prepare a poly(imide-amide) copolymer having a much higher molecular weight. As such, an article prepared from a poly(imide-amide) copolymer or a precursor thereof according to the embodiment may exhibit excellent mechanical, thermal, and optical properties due to the high molecular weight of the poly(imide-amide) copolymer or a precursor thereof according to the embodiment.

Accordingly, another embodiment provides an article obtained by curing the composition, and the article may be a film. The film may be, for example, a compensation film, a window film for a flexible display device, and the like, and is not limited thereto and may be applied to a various device requiring excellent optical properties, high thermal resistance, and good mechanical properties, such as, for example, an optical device, and the like.

Accordingly, still another embodiment provides an optical device including the article according to the embodiment, and the optical device may be a display device. The display device may include a display panel and an optical film positioned on one side of the display panel. The display panel may be a liquid crystal panel or an organic light emitting panel but is not limited thereto.

Far still another embodiment provides a method for preparing the article.

The method for preparing the article includes coating the composition according to an embodiment on a substrate, heating the coated substrate to remove a solvent, and curing the same by further heat treatment.

The heating to remove a solvent may be performed at a temperature greater than or equal to that converts the end group of Chemical Formula 1 of the poly(imide-amide) copolymer or a precursor thereof according to an embodiment in the composition into an end group of Chemical Formula 15:

NH₂—Ar²—* Chemical Formula 15

In Chemical Formula 15, Ar² is the same as defined in Chemical Formulae 1 to 3.

The article may be a film and the film may be an optical film, for example, a compensation film.

As aforementioned, the poly(imide-amide) copolymer or a precursor thereof according to an embodiment has a particular protecting group at one end, and when this protecting group is deblocked through a heat treatment an amino group is exposed. The amino group may be additionally polymerized with an anhydride end of another poly(imide-amide) copolymer or a precursor thereof. Accordingly, an article including the poly(imide-amide) copolymer or a precursor thereof obtained therefrom shows excellent mechanical properties, and all maintain excellent optical characteristics and the like of an article including a poly(imide-amide) copolymer prepared in a general method for preparing a poly(imide-amide) copolymer. Accordingly, the method for preparing the article from a poly(imide-amide) copolymer or a precursor thereof according to an embodiment may provide an article having excellent mechanical and thermal properties compared with a conventional method of preparing an article from a poly(imide-amide) copolymer or a precursor thereof, as the article may contain a poly(imide-amide) copolymer or a precursor thereof having increased molecular weight.

The following examples illustrate embodiments in more detail. However, these examples are exemplary, and the present disclosure is not limited thereto.

### EXAMPLES

### Synthesis Example 1: Preparation of an Oligomer-like-Diamine (SA1) Containing 70 mol % of an Amide Structural Unit as a Diamine Monomer

An amide structural unit-containing oligomer A1, as a diamine monomer, is prepared by reacting terephthaloyl dichloride (TPCI) and 2,2′-bis(trifluoromethyl)benzidine (TFDB), in accordance with Reaction Scheme 2:

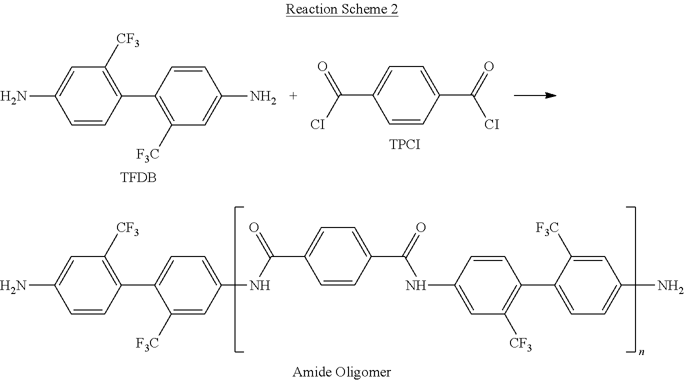

That is, 1 mole equivalent (0.122 mole, 39.2 grams) of 2,2′-bis(trifluoromethyl)benzidine (TFDB) and 2.8 mole equivalent (0.343 mole, 27.11 grams, g) of pyridine are dissolved in 700 g of N,N-dimethyl acetamide (DMAc) as a solvent in a round-bottomed flask, and 50 milliliters (ml) of DMAC is further added to the flask to dissolve the remaining TFDB. Then, 0.7 mole equivalent (0.086 mole, 17.4 g) of terephthaloyl chloride (TPCI) is divided into 4 portions, which are individually added, each portion at a time, to be mixed with the TFDB solution. The mixture is then vigorously stirred and reacted for 15 minutes at room temperature.

The resultant solution is further stirred under a nitrogen atmosphere for 2 hours, and then added to 7 liters of water containing 350 g of NaCl. The mixture is stirred for 10 minutes, a solid precipitate forms and is filtered, re-suspended twice in water, and then re-filtered by using 5 liters (L) of deionized water. The water remaining in the final washed product on the filter is removed as much as possible by thoroughly pressing the filtered precipitate on a filter. The precipitate is then dried at 90° C. under vacuum for 48 hours, to obtain an amide structural unit-containing oligomer product represented in Reaction Scheme 2, as a diamine monomer. The prepared oligomer Al containing 70 mol % of amide structural unit has a number average molecular weight of about 1,400 grams per mole (g/mol).

### Example 1: Preparation of a Poly(Imide-Amide) Copolymer Containing 10 mol % of a Thermal Reactive End Group Based on the Total Amount of Diamine

110 gram (g) of N,N-dimethylacetamide (DMAc) is added to a 250 mL double walled reactor, equipped with mechanical stirrer and nitrogen inlet at 25° C. under nitrogen atmosphere. 0.255 g (0.0011 mol) of di-tert-butyl dicarbonate (BOC₂O) and 0.163 mL (0.0012 mol) of triethylamine (TEA) are added thereto. Then, 16.59 g (0.0117 mol) of the oligomer SA1 prepared in Synthesis Example 1 is added to the reactor and reacted for 24 hours. Subsequently, 2.86 g (0.006 mol) of 4,4′—(hexafluoroisopropylidene)diphthalic anhydride (6-FDA), 1.55 g (0.005 mol) of 3,3′,4,4′-biphenyltetracarboxylic dianhydride (BPDA), and 20 g of DMAc are added. The reaction is carried out for 48 hours at 25° C. to obtain a poly(amic acid-amide) copolymer solution (13.6 wt % of solid content). To complete chemical imidization, 3.313 mL (0.035 mol) of acetic anhydride and 0.943 mL (0.0117 mol) of pyridine are slowly added to the poly(amic acid-amide) copolymer solution. The chemical imidization is carried out for 15 hours at 25° C.

The viscosity of the obtained poly(imide-amide) copolymer solution, and weight average molecular weight (Mw) and polydispersity index (PDI) of the poly(imide-amide) copolymer are measured by using the methods as described below, and the results are described in Table 1.

Solution viscosity is measured by AR 2000 rheometer using cone and plate geometry with cone diameter 40 mm and cone angle 2°, with respect to the poly(imide-amide) copolymer in DMAc (13.6 wt % of solid content).

Weight Average Molecular weight and PDI of the poly(imide-amide) copolymer is determine by Acquity APC Chromatograph (Waters) with DMF as a solvent at a flow rate 0.5 mL/min using polystyrene standard.

### Example 2: Preparation of a Poly(Imide-Amide) Copolymer Containing 30 mol % of a Thermal Reactive End Group Based on the Total Amount of Diamine

110 gram (g) of N,N-dimethylacetamide (DMAc) is added to a 250 mL double walled reactor, equipped with mechanical stirrer and nitrogen inlet at 25° C. under nitrogen atmosphere. 0.766 g (0.0035 mol) of di-tert-butyl dicarbonate (BOC₂O) and 0.489 mL (0.0035 mol) of triethylamine (TEA) are added thereto. Then, 16.59 g (0.0117 mol) of the oligomer SA1 prepared in Synthesis Example 1 is added to the reactor and reacted for 24 hours. Subsequently, 2.86 g (0.006 mol) of 4,4′-(hexafluoroisopropylidene)diphthalic anhydride (6-FDA), 1.55 g (0.005 mol) of 3,3′,4,4′-biphenyltetracarboxylic dianhydride (BPDA), and 20 g of DMAc are added. The reaction is carried out for 48 hours at 25° C. to obtain a poly(amic acid-amide) copolymer solution (13.6 wt % of solid content). To complete chemical imidization, 3.313 mL (0.035 mol) of acetic anhydride and 0.943 mL (0.0117 mol) of pyridine are slowly added to the poly(amic acid-amide) copolymer solution. The chemical imidization is carried out for 15 hours at 25° C.

The viscosity of the obtained poly(imide-amide) copolymer solution, and weight average molecular weight (Mw) and polydispersity index (PDI) of the poly(imide-amide) copolymer are measured by using the same methods as described in Example 1, and the results are described in Table 1.

### Comparative Example 1: Preparation of a Poly(Imide-Amide) Copolymer that does not Contain a Thermal Reactive End Group

110 gram (g) of N,N-dimethylacetamide (DMAc) is added to a 250 mL double walled reactor, equipped with mechanical stirrer and nitrogen inlet at 25° C. under nitrogen atmosphere. Then, 16.59 g (0.0117 mol) of the oligomer SA1 prepared in Synthesis Example 1 is added to the reactor and reacted for 24 hours. Subsequently, 2.86 g (0.006 mol) of 4,4′—(hexafluoro-isopropylidene)diphthalic anhydride (6-FDA), 1.55 g (0.005 mol) of 3,3′,4,4′-biphenyltetracarboxylic dianhydride (BPDA), and 20 g of DMAc are added. The reaction is carried out for 48 hours at 25° C. to obtain a poly(amic acid-amide) copolymer solution (13.6 wt % of solid content). To complete chemical imidization, 3.313 mL (0.035 mol) of acetic anhydride and 0.943 mL (0.0117 mol) of pyridine are slowly added to the poly(amic acid-amide) copolymer solution. The chemical imidization is carried out for 15 hours at 25° C.

The viscosity of the obtained poly(imide-amide) copolymer solution, and weight average molecular weight (Mw) and polydispersity index (PDI) of the poly(imide-amide) copolymer are measured by using the same methods as described in Example 1, and the results are described in Table 1.

TABLE 1

| | Amount of thermal | | | |
|---|---|---|---|---|
| | reactive end group | Solution | Mw | |
| Examples | (mol %) | viscosity (cP) | (by GPC) | PDI |
| Example 1 | 10 | 22,000 | 172,735 | 2.69 |
| Example 2 | 30 | 24,000 | 148,516 | 2.66 |
| Comparative | 0 | 54,000 | 191,962 | 2.64 |
| Example 1 | | | | |

As shown in Table 1, the solutions containing the poly(imide-amide) copolymers protected with a t-BOC group at one end according to Examples 1 and 2 show less than a half of the viscosity of that of the solution containing the poly(imide-amide) copolymer, which is not protected with a t-BOC group at one end, according to Comparative Example 1. This result is quite surprising because the weight average molecular weights of the poly(imide-amide) copolymers according to the Examples and Comparative Example are not that different from one another, compared with the observed respective viscosity difference. As the weight average molecular weights of the poly(imide-amide) copolymers according to Examples 1 and 2 are less than the weight average molecular weight of the poly(imide-amide) copolymer according to Comparative Example 1, one observes a trend that as the amount of the t-BOC group increases in the copolymer, the weight average molecular weight of the poly(imide-amide) copolymer containing the t-BOC group at one end decreases.

Consequently, although the poly(imide-amide) copolymers containing the t-BOC group at one end according to Examples 1 and 2 show lower weight average molecular weights than that of the poly(imide-amide) copolymer that does not contain the t-BOC group at one end according to Comparative Example 1 depending on the amount of the t-BOC group, the reduction of the weight average molecular weight of the poly(imide-amide) copolymer is not very substantial. On the contrary, the difference in viscosities of the poly(imide-amide) copolymer solutions according to the Examples 1 and 2 and Comparative Example 1 is very significant (i.e., one observes a substantial difference). That is, although the amounts of the poly(imide-amide) copolymers are the same as or similar to each other in the solutions, the viscosities of the solutions according to Examples 1 and 2 are much lower than that of the solution according to Comparative Example 1. As a result, the solution containing the poly(imide-amide) copolymer having the t-BOC group at one end has relatively low viscosity provides excellent processability, such as, for example, coating and the like. An article prepared from the solution does not show deterioration in mechanical and/or thermal properties as the weight average molecular weight of the poly(imide-amide) copolymer contained in the solution does not substantially reduce. The properties of the article may be confirmed by fabricating films from the poly(imide-amide) copolymers according to the Examples and Comparative Example 1 and measuring the properties of the films. Accordingly, fabrication of the films from the poly(imide-amide) copolymers according to the Examples and Comparative Example 1 and evaluation of properties of the prepared films are hereinbelow described in detail.

### Preparation and Evaluation of Film

Each poly(imide-amide) copolymer solution according to Examples 1 and 2 and Comparative Example 1 is coated on a glass substrate and casted, and dried on a heating plate at 130° C. for 40 minutes. Then, the films are isolated from the glass substrates and introduced into a furnace, where the temperature is increased from room temperature to 277° C. at a rate of 10° C. per minute, maintained at 277° C. for about 11 minutes, and cooled down to room temperature to obtain poly(imide-amide) copolymer films.

The weight average molecular weight (Mw) and polydispersity index (PDI) of the poly(imide-amide) copolymers contained in the obtained films, and thickness, optical characteristics, and mechanical and thermal properties of the films are measured. The optical characteristics include average transmittance (%) at the total wavelength, yellowness index (YI), and haze. The mechanical properties include modulus in Gigapascal (GPa), and tensile stress at break in Megapascal (MPa). The thermal properties include glass transition temperature (Tg). The results are shown in Table 2. Thickness of the film, weight average molecular weight of the poly(imide-amide) copolymer, optical characteristics, mechanical properties, and thermal properties of the films are measured as below:

(1) Thickness of film is measured by using Micrometer (Mitutoyo Co. Ltd.).

(2) A weight average molecular weight of the film is measured by dissolving a film in DMF, measuring weight average molecular weight of the same by GPC, and comparing the result with that of the poly(imide-amide) copolymer in the solution before fabricating the film. Specifically, a weight average molecular weight is measured by using DMF as a solvent at a flow rate of 0.5 mL/min through Acquity APC Chromatograph (Waters) according to a polystyrene standard.

(3) Optical characteristics of the film (transmittance, a yellowness index, and haze) are measured by using “Konica Minolta CM3600d” spectrophotometer in a transmittance opacity/haze mode. The transmittance at the total wavelength is measured in a range of 360 nm to 700 nm wavelength.

(4) A modulus and a tensile modulus are measured by using Universal Tensile Machine (Instron) according to an ASTM D882 method. For measuring the modulus and tensile modulus, a film having a width of 1 cm, and a length between the grips of 10 cm is used, and the cross head speed is 10 mm/min.

(5) In order to determine a glass transition temperature of a film, dynamic mechanical analysis is performed for the obtained films by using DMA (Dynamic Mechanical Analyzer, TA Instruments Co. Ltd., (DMA Q800)). It is performed at temperature sweep mode (frequency 1 Hz, Oscillation Strain 0.2%, Static Force 0.01 N) under tension mode at a speed of 5° C. per minute from 25° C. to 400° C., and the Tg is determined at the maximum value of the tangent delta.

TABLE 2

| | | | | | | Tensile | | weight | |
|---|---|---|---|---|---|---|---|---|---|
| | | Tr@ | | | | stress at | | average | |
| | Thickness | total, | | | Modulus | break | | molecular | |
| | (μm) | (%) | Y.I. | Haze | (GPa) | (MPa) | Tg (° C.) | weight (Mw) | PDI |
| Example 1 | 49 | 88.68 | 2.39 | 0.56 | 6.5 | 191.9 | 368.23 | 185,911 | 2.41 |
| Example 2 | 58 | 88.45 | 3.1 | 0.45 | 6.1 | 209.7 | 377.20 | 200,039 | 2.37 |
| Comparative | 52 | 88.56 | 2.41 | 0.61 | 6.4 | 199.2 | 368.34 | 190,275 | 2.52 |
| Example 1 | | | | | | | | | |

As shown from Table 2, the film prepared from the poly(imide-amide) copolymer 10 mol % of which is protected with a t-BOC group at one end according to Example 1 has improved transmittance, YI, and haze compared with the film according to Comparative Example 1, of which the poly(imide-amide) copolymer is not protected with a t-BOC group at one end, though Comparative Example 1 has the same composition as the poly(imide-amide) copolymer of Example 1 except for the t-BOC end group. Meanwhile, the film according to Example 2 prepared from the poly(imide-amide) copolymer 30 mol % of which is protected with a t-BOC group at one end shows somewhat deteriorated optical properties except for the haze compared with those of the film according to Comparative Example 1. In this case, however, the deterioration is not very substantial.

With respect to mechanical properties, the modulus of the film according to Example 1 exhibits a slight improvement compared with the film according to Comparative Example 1, and the modulus of the film according to Example 2, in which 30 mol % of the poly(imide-amide) copolymer is protected with a t-BOC group at one end, exhibits a slight reduction in modulus compared with the film according to Comparative Example 1. However, the tensile stress at break of the film according to Example 2 is the highest among the films according to the Examples and Comparative Example 1. With respect to the thermal properties, the Tg of the film according to Example 2 is the highest among the films according to the Examples and Comparative Example 1, and thus, it is noted that the film according to Example 2 exhibits the highest thermal properties.

Meanwhile, as shown from Table 1, regardless of the lowest weight average molecular weight of the poly(imide-amide) copolymer according to Example 2 as 30 mol % of the poly(imide-amide) copolymer is protected by the t-BOC group at one end, the weight average molecular weight of the film prepared from the poly(imide-amide) copolymer according to Example 2 is the highest among the films according to the Examples and Comparative Example 1. From this, it is noted that when 30 mol % of the poly(imide-amide) copolymer is protected with the t-BOC at one end, the weight average molecular weight of the poly(imide-amide) copolymer is a slightly lower, and thus, an article prepared from the poly(imide-amide) copolymer may exhibit further improved mechanical properties. These mechanical properties include a tensile stress at break, and thermal properties, such as, for example, T_{g}, as the poly(imide-amide) copolymer may be further polymerized by the deprotection of the t-BOC group at one end to form a poly(imide-amide) copolymer having a weight average molecular weight that is further increased.

The PDI of the poly(imide-amide) copolymers according to the Examples and Comparative Example 1, or of the poly(imide-amide) copolymers in the films according to the Examples and Comparative Example 1 are similar to each other, and thus, it is noted that the poly(imide-amide) copolymers with relative homogeneous weight average molecular weights (low PDI) are obtained.

While this disclosure has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A poly(imide-amide) copolymer or its precursor comprising
two ends and a main chain located between the two ends,
a group represented by Chemical Formula 1 at one end of the two ends, and
a structural unit represented by Chemical Formula 7, and at least one of a structural unit represented by Chemical Formula 2 or a structural unit represented by Chemical Formula 3 in the main chain: 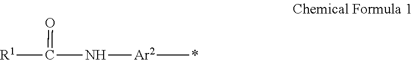
wherein, in Chemical Formula 1,
R¹ is a C4 to C10 tertiary alkoxy group, C3 to C10 cycloalkoxy group, a R^{a}—CH═CH—O— group wherein Rₐ is hydrogen or substituted or unsubstituted C1 to C8 alkyl group, a R^{b}—CH═CH—CH₂—O— group wherein R_{b} is hydrogen or substituted or unsubstituted C1 to C7 alkyl group, a substituted or unsubstituted phenyloxy group, a substituted or unsubstituted benzyloxy group, or a 9-fluorenylmethyloxy group, and
Ar² comprises a substituted or unsubstituted C6 to C30 aromatic organic group, wherein the substituted or unsubstituted C6 to C30 aromatic organic group is present as a substituted or unsubstituted single aromatic ring; a fused ring comprising two or more substituted or unsubstituted aromatic rings; or a ring system comprising two or more of the substituted or unsubstituted single aromatic ring and/or the fused ring that are linked by a single bond, a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— wherein 1≤p≤10, —(CF₂)_{q}— wherein 1≤q≤10, —C(CH₃)₂—, —C(CF₃)₂—, —C(═O)NH—, or a combination thereof; 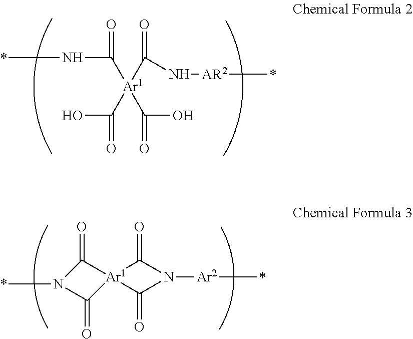
wherein, in Chemical Formula 2 or Chemical Formula 3,
Ar² is the same as defined in Chemical Formula 1,
Ar¹ is a substituted or unsubstituted C6 to C30 aromatic organic group, wherein the substituted or unsubstituted C6 to C30 aromatic organic group is present as a substituted or unsubstituted single aromatic ring; a fused ring including two or more substituted or unsubstituted aromatic rings; a group represented by Chemical Formula 4, or a combination thereof: 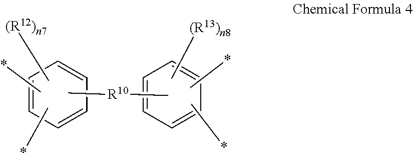
wherein, in Chemical Formula 4,
R¹⁰ is a single bond, —O—, —S—, —C(═O)—, —CH(OH)—, —C(═O)NH—, —S(═O)₂—, —Si(CH₃)₂—, —(CH₂)ₚ— wherein 1≤p≤10, —(CF₂)_{q}— wherein 1≤q≤10, —C(CₙH₂ₙ₊₁)₂— or —C(CₙF₂ₙ₊₁)₂— wherein 1≤n≤10, —(CH₂)ₚ—C(CₙH₂ₙ₊₁)₂—(CH₂)_{q}— or —(CH₂)ₚ—C(CₙF₂ₙ₊₁)₂—(CH₂)_{q}— wherein 1≤n≤10, 1≤p≤10, and 1≤q≤10, or a combination thereof,
R¹² and R¹³ are independently a halogen, a hydroxy group, a substituted or unsubstituted C1 to C10 aliphatic organic group, a substituted or unsubstituted C6 to C20 aromatic organic group, a —OR²⁰¹ group wherein R²⁰¹ is a C1 to C10 aliphatic organic group), or a —SiR²¹⁰R²¹¹R²¹² group wherein R²¹⁰, R²¹¹, and R²¹² are independently hydrogen or a C1 to C10 aliphatic organic group), and
n7 and n8 are independently one of integers of 0 to 3; and 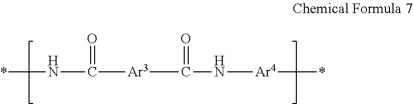
wherein, in Chemical Formula 7,
Ar³ is a substituted or unsubstituted phenylene group, or a substituted or unsubstituted biphenylene group, and
Ar⁴ is the same as Ar² defined in Chemical Formula 1.

2. The poly(imide-amide) copolymer or its precursor of claim 1, wherein R¹ of Chemical Formula 1 is a t-butoxy group, a 2-methyl-2-butoxy group, a C10 cycloalkoxy group, vinyloxy group, allyloxy group, an n-nitrophenyloxy group, a nitrobenzyloxy group, or a benzyloxy group.

3. The poly(imide-amide) copolymer or its precursor of claim 1, wherein R¹ of Chemical Formula 1 is a t-butoxy group or a benzyloxy group.

4. The poly(imide-amide) copolymer or its precursor of claim 1, wherein Ar² of Chemical Formula 1, Chemical Formula 2, and Chemical Formula 3 is independently a group where two substituted or unsubstituted aromatic rings are linked by a single bond, a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— wherein 1≤p≤10, —(CF₂)_{q}— wherein 1≤q≤10, —C(CH₃)₂—, —C(CF₃)₂—, —C(═O)NH—, or a combination thereof.

5. The poly(imide-amide) copolymer or its precursor of claim 1, wherein Ar² of Chemical Formula 1, Chemical Formula 2, and Chemical Formula 3 is independently a group where two aromatic rings, each of which is substituted with an electron withdrawing group, are linked by a single bond.

6. The poly(imide-amide) copolymer or its precursor of claim 1, wherein Ar² of Chemical Formula 1, Chemical Formula 2, and Chemical Formula 3 is represented by the following chemical formula:

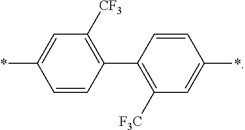

7. The poly(imide-amide) copolymer or its precursor of claim 1, wherein R¹⁰ of Chemical Formula 4 is a single bond, —O—, —S—, —C(═O)—, —CH(OH)—, —C(═O)NH—, —S(═O)₂—, —Si(CH₃)₂—, —(CH₂)ₚ— wherein 1≤p≤3, —(CF₂)_{q}— wherein 1≤q≤3, —C(CₙH₂ₙ₊₁)₂— or —C(CₙF₂ₙ₊₁)₂— wherein 1≤n≤10, —(CH₂)ₚ—C(CₙH₂ₙ₊₁)₂—(CH₂)_{q}— or —(CH₂)ₚ—C(CₙF₂ₙ₊₁)₂—(CH₂)_{q}— wherein 1≤n≤10, 1≤p≤3, and 1≤q≤3, or a combination thereof.

8. The poly(imide-amide) copolymer or its precursor of claim 1, wherein Ar¹ of Chemical Formula 2 or Chemical Formula 3 comprises the group represented by Chemical Formula 4.

9. The poly(imide-amide) copolymer or its precursor of claim 8, wherein R¹⁰ of Chemical Formula 4 comprises a single bond, or —C(CF₃)₂—.

10. The poly(imide-amide) copolymer or its precursor of claim 1, wherein Ar³ of Chemical Formula 7 is a substituted or unsubstituted phenylene group, and Ar⁴ of Chemical Formula 7 is the group where two of substituted or unsubstituted phenylene groups are linked by a single bond.

11. The poly(imide-amide) copolymer or its precursor of claim 1, wherein Ar³ of Chemical Formula 7 is an unsubstituted phenylene group, and Ar⁴ of Chemical Formula 7 is represented by the following chemical formula:

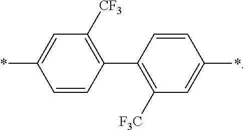

12. The poly(imide-amide) copolymer or its precursor of claim 1, wherein the poly(imide-amide) copolymer or its precursor comprises one of the group represented by Chemical Formula 8 or Chemical Formula 9 at the other end of the two ends: 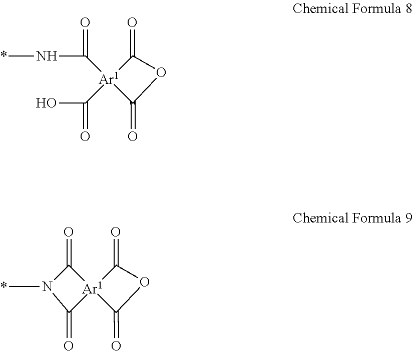
wherein, in Chemical Formula 8 and Chemical Formula 9,
Ar¹ is the same as defined in Chemical Formula 2 or Chemical Formula 3 in claim 1.

13. A composition comprising the poly(imide-amide) copolymer or its precursor of claim 1 and a solvent.

14. A composition for preparing a poly(imide-amide) copolymer or its precursor comprising a compound represented by Chemical Formula 11, and a compound represented by Chemical Formula 12: 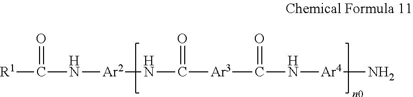
wherein, in Chemical Formula 11,
R¹ is a C4 to C10 tertiary alkoxy group, C3 to C10 cycloalkoxy group, a R^{a}—CH═CH—O— group wherein Rₐ is hydrogen or substituted or unsubstituted C1 to C8 alkyl group, a R^{b}—CH═CH—CH₂—O— group wherein R_{b} is hydrogen or substituted or unsubstituted C1 to C7 alkyl group, a substituted or unsubstituted phenyloxy group, a substituted or unsubstituted benzyloxy group, or a 9-fluorenylmethyloxy group,
Ar² and Ar⁴ are independently a substituted or unsubstituted C6 to C30 aromatic organic group, wherein the substituted or unsubstituted C6 to C30 aromatic organic group is present as a substituted or unsubstituted single aromatic ring; a fused ring comprising two or more substituted or unsubstituted aromatic rings; or a ring system comprising two or more of the substituted or unsubstituted single aromatic ring and/or the fused ring that are linked by a single bond, a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— wherein 1≤p≤10, —(CF₂)_{q}— wherein 1≤q≤10, —C(CH₃)₂—, —C(CF₃)₂—, —C(═O)NH—, or a combination thereof;
A³ is a substituted or unsubstituted phenylene group, or a substituted or unsubstituted biphenylene group, and
n0 is an integer greater than or equal to 1; 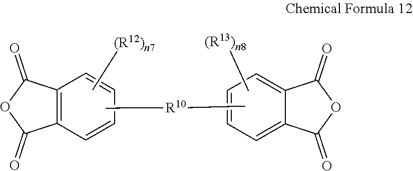
wherein in Chemical Formula 12,
R¹⁰ is a single bond, —O—, —S—, —C(═O)—, —CH(OH)—, —C(═O)NH—, —S(═O)₂—, —Si(CH₃)₂—, —(CH₂)ₚ— wherein 1≤n≤10, —(CF₂)_{q}— wherein 1≤q≤10, —C(CₙH₂ₙ₊₁)₂— or —C(CₙF₂ₙ₊₁)₂— wherein 1≤n≤10, —(CH₂)ₚ—C(CₙH₂ₙ₊₁)₂—(CH₂)_{q}— or —(CH₂)ₚ—C(CₙF₂ₙ₊₁)₂—(CH₂)_{q}— wherein 1≤n≤10, 1≤p≤10, and 1≤q≤10, or a combination thereof,
R¹² and R¹³ are each independently a halogen, a hydroxy group, a substituted or unsubstituted C1 to C10 aliphatic organic group, a substituted or unsubstituted C6 to C20 aromatic organic group, a —OR²⁰¹ group wherein R²⁰¹ is a C1 to C10 aliphatic organic group, or a —SiR²¹⁰R²¹¹R²¹² group wherein R²¹⁰, R²¹¹, and R²¹² are independently hydrogen or a C1 to C10 aliphatic organic group), and
n7 and n8 are each independently one of integers of 0 to 3.

15. The composition of claim 14, wherein both of the Ar² and Ar⁴ of Chemical Formula 11 are represented by the following chemical formula:

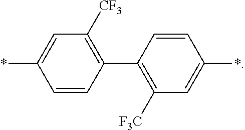

16. The composition of claim 14, wherein the compound represented by Chemical Formula 12 comprises at least one of a compound represented by Chemical Formula 12-1 or a compound represented by Chemical Formula 12-2: 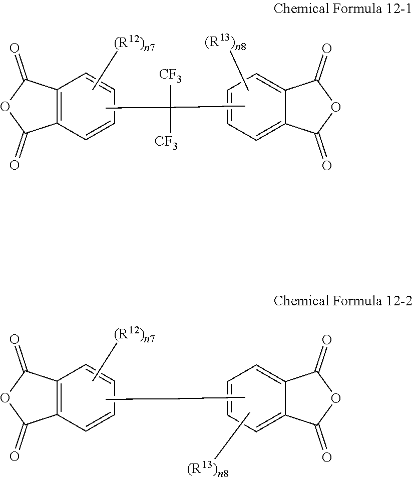
wherein in Chemical Formula 12-1 and Chemical Formula 12-2,
R¹², R¹³, n7, and n8 are each independently the same as defined in Chemical Formula 12.

17. The composition of claim 14, wherein the composition further comprises a compound represented by Chemical Formula 14:
NH₂—Ar²—NH₂ Chemical Formula 14
wherein in Chemical Formula 14,
Ar² is the same as defined in Chemical Formula 11.

18. An article comprising the poly(imide-amide) copolymer of claim 1.

19. A method for preparing an article, comprising
coating the composition of claim 14 on a substrate, and
heating the same to remove a solvent at a temperature greater than or equal to which the end group represented by Chemical Formula 1 of the poly(imide-amide) copolymer or its precursor in the composition is converted to a group represented by Chemical Formula 15, and the poly(imide-amide) copolymer or its precursor polymerizes to form a chain-extended poly(imide-amide) copolymer: 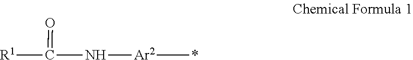
wherein, in Chemical Formula 1,
R¹ is a C4 to C10 tertiary alkoxy group, a C3 to C10 cycloalkoxy group, a R^{a}—CH═CH—O— group wherein Rₐ is hydrogen or substituted or unsubstituted C1 to C8 alkyl group, a R^{b}—CH═CH—CH₂—O— group wherein R_{b} is hydrogen or substituted or unsubstituted C1 to C7 alkyl group, a substituted or unsubstituted phenyloxy group, a substituted or unsubstituted benzyloxy group, or a 9-fluorenylmethyloxy group, and
Ar² comprises a substituted or unsubstituted C6 to C30 aromatic organic group, wherein the substituted or unsubstituted C6 to C30 aromatic organic group is present as a substituted or unsubstituted single aromatic ring; a fused ring comprising two or more substituted or unsubstituted aromatic rings; or a ring system comprising two or more of the substituted or unsubstituted single aromatic ring and/or the fused ring that are linked by a single bond, a fluorenylene group, a substituted or unsubstituted C1 to C10 cycloalkylene group, a substituted or unsubstituted C6 to C15 arylene group, —O—, —S—, —C(═O)—, —CH(OH)—, —S(═O)₂—, —Si(CH₃)₂—, —(CH₂)ₚ— wherein 1≤p≤10, —(CF₂)_{q}— wherein 1≤q≤10, —C(CH₃)₂—, —C(CF₃)₂—, —C(═O)NH—, or a combination thereof;
NH₂—Ar²—* Chemical Formula 15
wherein, in Chemical Formula 15,
Ar² is the same as defined in Chemical Formula 1.

20. A display device comprising the article of claim 18.
